(19) United States
(12) Patent Application Publication
(10) Pub. No.: US 2008/0055418 A1
(43) Pub. Date: Mar. 6, 2008

(54) Portable terminal apparatus

(75) Inventor: Che-Wei Hsu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/647,291

(22) Filed: Dec. 29, 2006

(30) Foreign Application Priority Data
Aug. 31, 2006 (TW) 095132242

(51) Int. Cl. H04N 5/225

(52) U.S. Cl. 348/207.99

(57) ABSTRACT

A portable terminal apparatus includes a main body, a power key and a digital camera module. The power key is disposed on and exposed from the main body. The power key is pervious to light. The digital camera module is disposed inside the main body and has a lens device facing the power key.

### BACKGROUND OF THE INVENTION

1. Field of Invention

The invention relates to a portable terminal apparatus, and, in particular, to a portable terminal apparatus having a digital camera module.

2. Related Art

With the development of the technology, various portable terminal apparatuses, such as personal digital assistants (PDAs), smart phones, PDA phones, and the like, have been developed. These portable terminal apparatuses make human life convenient, and have the ever increasing operation functions in order to meet the requirements of the modern user. In addition to the basic communication functions, these apparatuses further perform functions such as information processing, information storage, audio recording, and MP3 playing. In addition, if the portable terminal apparatus has a digital camera module, it has a photographing function, and portable terminal apparatuses with photographing functions have become the popular electronic products in the market.

On the other hand, as the functions of these portable terminal apparatuses are increasing, the price thereof and amount of information stored therein are increasing correspondingly. So, it is an important issue to prevent these apparatuses from being misused and prevent the stored information from being accessed or stolen from the user. Currently, many portable terminal apparatuses have mechanisms of authenticating the identity of the user. In general, there are two ways of authenticating the identity, which include a password recognition method and a fingerprint recognition method. Using the password recognition method, a typical phone can be programmed to set a PIN code and a booting password to provide the protection. However, this technology is not very secure because the password can be easily cracked or stolen, thereby allowing the unauthorized use of the phone and the information inside.

The fingerprint recognition method ensures a very high level of privacy, almost guaranteeing that any information in the portable terminal apparatus cannot be read by the unauthorized user. In addition, the apparatus can be used conveniently because the user does not have to memorize a complicated password, and does not have to worry about the forgetting of the password. Currently, the design of the fingerprint recognition method has an additional electronic element, such as a fingerprint recognition scan chip, to achieve the function of fingerprint recognition. However, the design of this additional electronic element increases the manufacturing cost and lengthens the time required to research, develop and manufacture the product. It is possible to reduce the product's production time and cost while enhancing the efficiency of design if an inherent element of the portable terminal apparatus, such as the digital camera module, can be used to achieve the fingerprint recognition function.

Thus, it is an important subject of the invention to provide a portable terminal apparatus capable of achieving the fingerprint recognition function using the digital camera module, thereof so as to enhance the product functionality and privacy.

### SUMMARY OF THE INVENTION

In view of the foregoing, the invention is to provide a digital camera module having a fingerprint recognition function.

To achieve the above, the invention discloses a portable terminal apparatus including a main body, a power key and a digital camera module. The power key is disposed on and exposed from the main body, and the power key is pervious to light. The digital camera module is disposed inside the main body and has a lens device facing the power key.

As mentioned above, the portable terminal apparatus of the invention has the lens device of the digital camera module facing the power key, and the power key is pervious to light. So, when the finger of the user presses the power key, the digital camera module can photograph the finger and store the fingerprint image into a memory of the portable terminal apparatus. When the digital camera module again obtains another fingerprint image, the portable terminal apparatus can perform a comparison such that the fingerprint recognition operation may be implemented. Compared with the prior art, the invention only utilizes the inherent devices, such as the digital camera module and the power key of the portable terminal apparatus to implement the fingerprint recognition function. So, the production time and cost can be reduced, and the efficiency of use, the reliability and the privacy of the product can be enhanced.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a portable terminal apparatus having a lens device facing a power key according to a preferred embodiment of the invention;

FIG. 2 is a partially schematic illustration showing the portable terminal apparatus having a push-push type structure in a pressed state according to the preferred embodiment of the invention;

FIG. 3 is a partially schematic illustration showing the portable terminal apparatus having the push-push type structure in a recovered state according to the preferred embodiment of the invention;

FIG. 4 is a schematic illustration showing the portable terminal apparatus according to the preferred embodiment of the invention, wherein the lens device faces a photographing opening;

FIG. 5 is a partially schematic illustration showing the portable terminal apparatus of FIG. 4; and

FIG. 6 is a block diagram showing the portable terminal apparatus according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

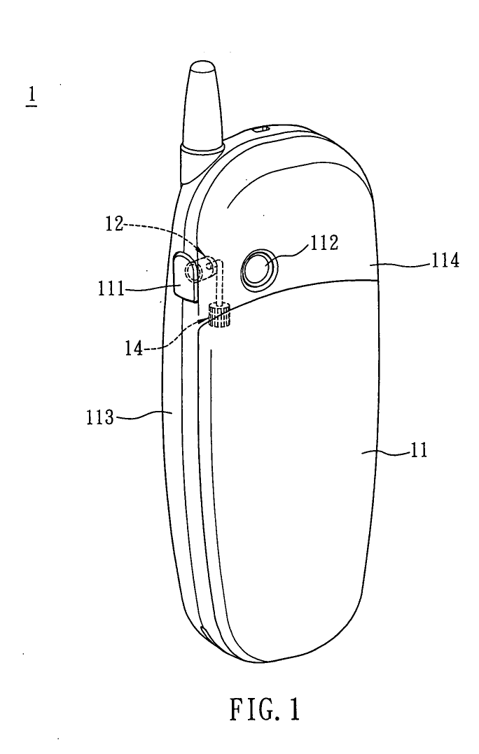

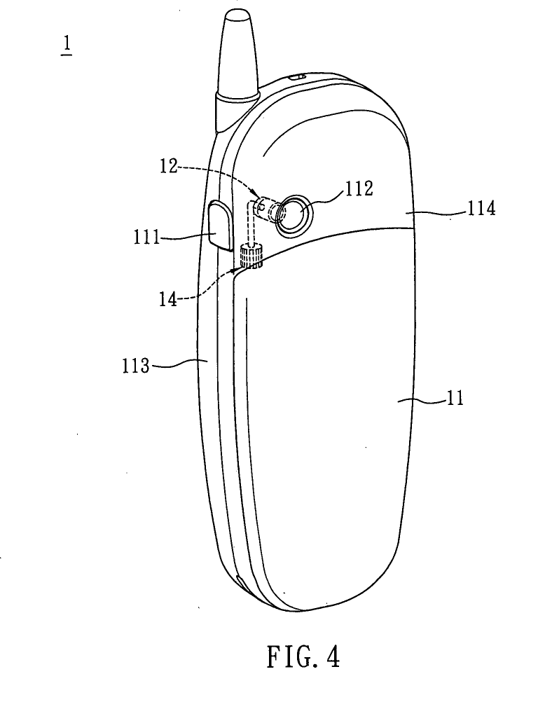

Referring to FIG. 1, a portable terminal apparatus 1 according to the preferred embodiment of the invention has a main body 11, on which a power key 111 is disposed and a photographing opening 112 is formed. The power key 111 and the photographing opening 112 are respectively disposed on and exposed from two adjacent side surfaces 113 and 114 of the main body 11. In addition, the portable terminal apparatus 1 of this embodiment has a photographing function. Thus, the portable terminal apparatus 1 further has a digital camera module 12, which is disposed inside the main body 11 and has a lens capable of being actuated to rotate to face the power key 111 (see FIG. 1) or the photographing opening 112 (see FIG. 4) by an actuating mechanism 14 according to an operation mode of the portable terminal apparatus 1. In this embodiment, the portable terminal apparatus 1 may be a personal digital assistant, a mobile communication apparatus or a notebook computer. In this case, the apparatus 1 is a mobile communication apparatus.

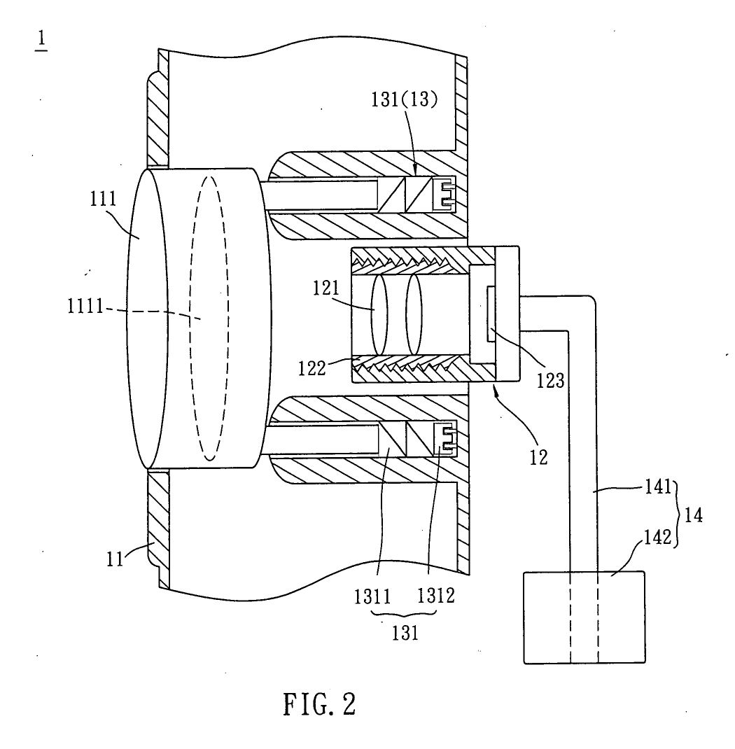

As shown in FIG. 2, the power key 111 and the digital camera module 12 of the portable terminal apparatus 1 will be described in detail, wherein the lens faces the power key 111, as shown in FIG. 1. In this embodiment, the power key 111 is disposed on and exposed from the main body 11 such that the user can press the power key 111. In addition, the power key 111 is pervious to light and is preferably transparent and has a convex lens 1111 disposed therein. In addition, the digital camera module 12 has a lens device 121, a lens barrel 122 and a photosensitive device 123. The lens device 121 is disposed inside the lens barrel 122 and faces the power key 111 and has a plurality of lenses. The photosensitive device 123 is disposed on a light path traversing the power key 111 and the lens device 121 such that the photosensitive device 123 receives a light ray (an image) passing through the power key 111 and the lens device 121. Herein, the photosensitive device 123 may be a CCD (Charge Coupled Device) or a CMOS (Complementary Metal-Oxide Semiconductor). In addition, the digital camera module 12 of this embodiment has a macro mode for photographing the fingerprint at a short distance.

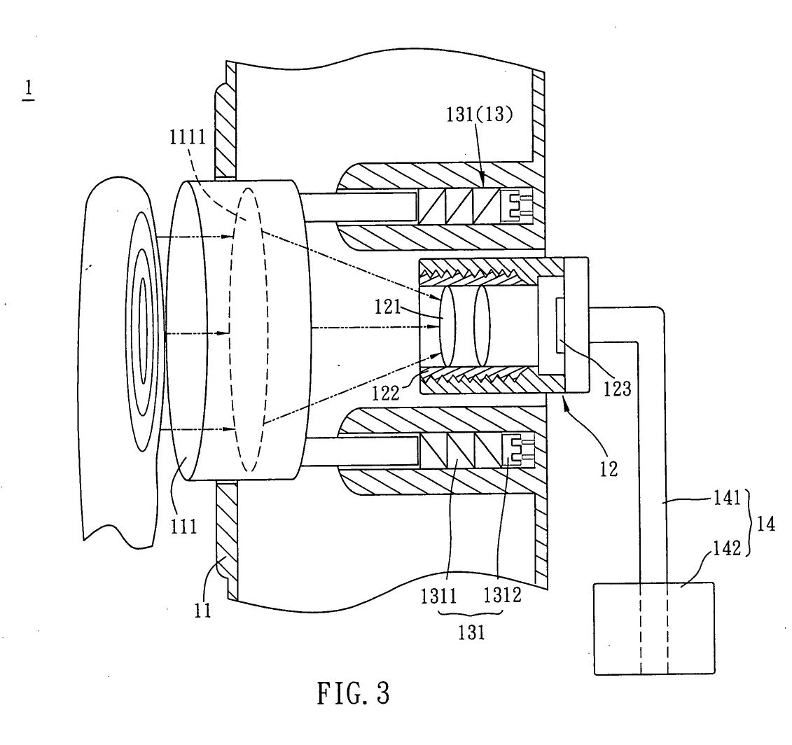

The portable terminal apparatus 1 of this embodiment further has a starting module 13 having two push-push type structures 131. Herein, the push-push type structure 131 is disposed inside the main body 11 and adjacent to the power key 111. In addition, the lens device 121 and the lens barrel 122 of the digital camera module 12 are disposed between the two push-push type structures 131. Herein, each push-push type structure 131 has an elastic member 1311 and two contact points 1312. One of the contact points 1312 is fixed and the other one of the contact points 1312 is connected to the elastic member 1311. Herein, the elastic member 1311 may be, for example, a spring structure. The contact point 1312 may be, for example, a hook structure or a soft carbon. In addition, the push-push type structure 131 has a pressed state and a recovered state. In this embodiment, FIG. 2 shows the pressed state. When the push-push type structure 131 is in the pressed state, the elastic member 1311 is pressed and the contact points 1312 contact each other by way of engagement. In addition, FIG. 3 shows the recovered state. When the push-push type structure 131 is in the recovered state, the elastic member 1311 is recovered and the two contact points 1312 are separated from each other. When the push-push type structure 131 is changed from the pressed state to the recovered state, the power key 111 is also pushed by the push-push type structure 131 and exposed from the main body 11.

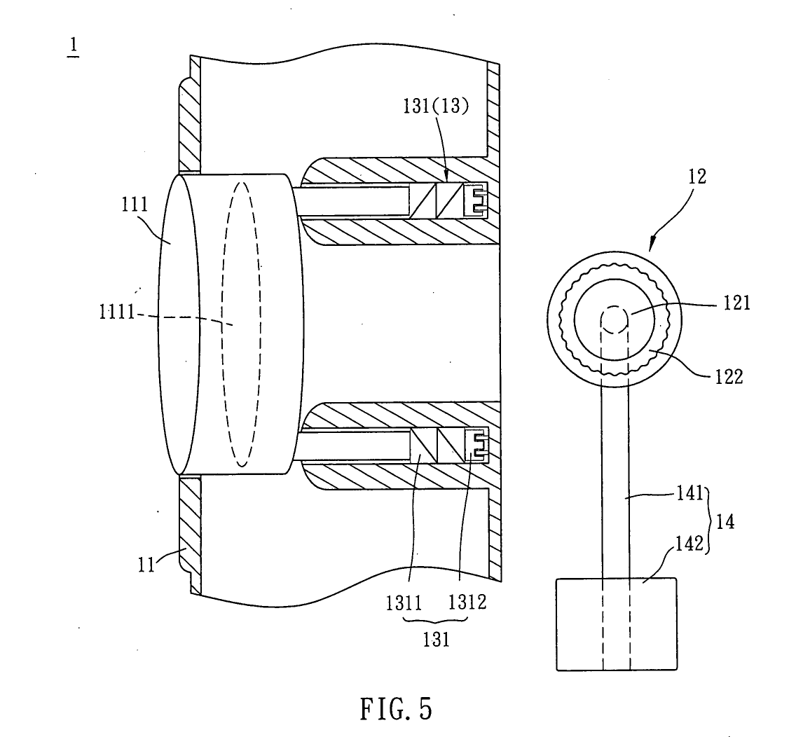

In this embodiment, the actuating mechanism 14 is disposed inside the main body 11 and is connected to the digital camera module 12. Herein, the actuating mechanism 14 has a rotatable arm 141 and a hinge 142. The rotatable arm 141 is connected to the digital camera module 12 and the hinge 142 such that the rotatable arm 141 and the lens device 121 can be rotated about the hinge 142. The portable terminal apparatus 1 of this embodiment has a fingerprint recognition mode and a photographing mode. In the fingerprint recognition mode, the actuating mechanism 14 actuates the lens device 121 to face the power key 111, as shown in FIGS. 1 to 3. Thus, the lens device 121 can capture an image of a fingerprint through the power key 111 so as to perform the fingerprint recognition operation. In addition, in the photographing mode, the actuating mechanism 14 actuates the lens device 121 to face the photographing opening 112, as shown in FIGS. 4 and 5. Thus, the lens device 121 can photograph the aligned object or image to be photographed through the photographing opening 112 so as to perform the photographing operation. In brief, the lens device 121 can be rotated to face the power key 111 or be rotated to face the photographing opening 112 through the actuating mechanism 14. In this embodiment, the lens device 121 is rotated about 90 degrees to face the power key 111 or the photographing opening 112 such that the lens device 121 directly faces the power key 111 or the photographing opening 112. In addition to the lens device 121, the lens barrel 122 and the photosensitive device 123 of this embodiment may also be rotated simultaneously through the actuating mechanism 14.

It is to be noted that the actuating mechanism 14 actuates the lens device 121 by way of rotation because the power key 111 and the photographing opening 112 of this embodiment are disposed on the different side surfaces 113 and 114. Of course, if the positions of the power key 111 and the photographing opening 112 are changed, the actuating mechanism 14 may actuate the lens device 121 according to other methods. For example, when the power key 111 and the photographing opening 112 are disposed on the same side surface of the main body 11, the actuating mechanism 14 may actuate the lens device 121 by way of transversal movement such that the lens device 121 faces the power key 111 or the photographing opening 112 according to the movement of the actuating mechanism 14.

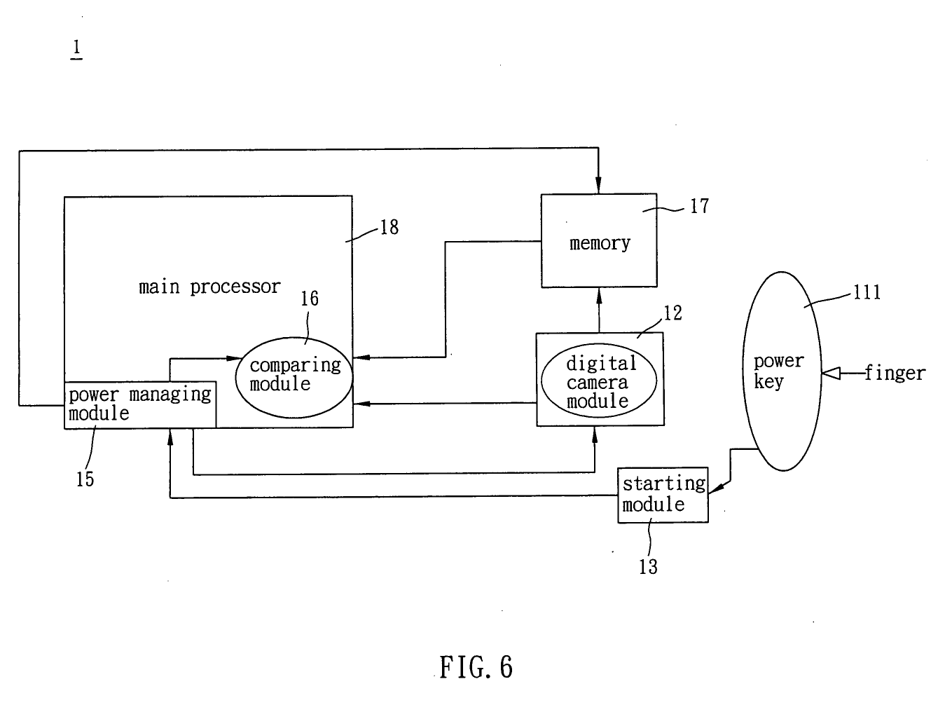

As shown in FIG. 6, the portable terminal apparatus 1 of this embodiment will be described in detail. In this embodiment, the portable terminal apparatus 1 further has a power managing module 15, a comparing module 16 and a memory 17. The power managing module 15 manages the power allocation of the portable terminal apparatus 1 and is electrically connected to the digital camera module 12, the comparing module 16 and the memory 17. In addition, the comparing module 16 has the function of comparing signals and is electrically connected to the digital camera module 12 and the memory 17. In this embodiment, the power managing module 15 and the comparing module 16 are implemented using logic circuits, and are parts of the circuit of a main processor 18 of the portable terminal apparatus 1. Herein, the main processor 18 may be a central processing unit (CPU).

Of course, the comparing module 16 may also be implemented using another chip or software. In this embodiment, the circuit with the comparing function disposed in the main processor 18 serves as the comparing module 16. So, the efficiency of the portable terminal apparatus 1 can be enhanced, and the cost can be reduced. In addition, the memory 17 in this embodiment may be an EEPROM (Electrically Erasable Programmable Read Only Memory). In addition, the starting module 13 further has a starting circuit (not shown), which is electrically connected to the fixed contact points 1312, and the starting module 13 is electrically connected to the power managing module 15 through the starting circuit.

How the portable terminal apparatus 1 of this embodiment achieves the fingerprint recognition function will be described with reference to FIG. 6 in conjunction with FIGS. 2 and 3. First, the user has to store his/her fingerprint image into the portable terminal apparatus 1 to serve as the reference to be compared with other fingerprint images.

In this embodiment, the user enables a safety mechanism through the operation system when the portable terminal apparatus 1 is ON. After the safety mechanism is enabled, the actuating mechanism 14 actuates the lens device 121 of the digital camera module 12 to face the power key 111. At this time, the user can use a finger, such as a little thumb, to completely press the power key 111. After the power key 111 has been pressed, the push-push type structure 131 of the starting module 13 is changed from the pressed state (see FIG. 2) to the recovered state (see FIG. 3). At this time, the digital camera module 12 starts to capture the fingerprint of the user. The image of the finger of the user is focused by the convex lens 1111 of the power key 111 and then refracted and converged by the lens device 121. Thereafter, the photosensitive device 123 receives the image to generate induced charges, which are processed into a fingerprint image. Then, the fingerprint image is transferred to the memory 17 of the portable terminal apparatus 1.

Thereafter, the portable terminal apparatus 1 can recognize the fingerprint according to the fingerprint image. In this embodiment, when the portable terminal apparatus 1 is in a shutdown state or in a power-saving mode, the fingerprint recognition process has to be performed. When the user himself/herself or another user wants to use the portable terminal apparatus 1 in the shutdown state or the power-saving mode, he/she has to use his/her finger to press the power key 111. After the user presses the power key 111, the push-push type structure 131 of the starting module 13 is changed from the pressed state (FIG. 2) into the recovered state (FIG. 3). At this time, the two contact points 1312 of the push-push type structure 131 are separated, and the starting circuit of the starting module 13 transmits a starting signal to the power managing module 15, which supplies the power to the digital camera module 12, the comparing module 16 and the memory 17.

The digital camera module 12 starts to capture the fingerprint image of the pressed finger, wherein the process of capturing the fingerprint image has been described hereinabove, so detailed descriptions thereof will be omitted. After the fingerprint image has been completely captured, the comparing module 16 compares the captured fingerprint image with the fingerprint image stored in the memory 17. If the two fingerprint images do not match with each other, the portable terminal apparatus 1 is kept in the shutdown state or the power-saving mode. If the two fingerprint images match with each other, the comparing module 16 transmits a booting signal or a wake-up signal to the main processor 18 such that the portable terminal apparatus 1 enters the booted mode or the normal operation mode from the shutdown state or the power-saving mode. In addition, when the portable terminal apparatus 1 is booted or operates normally, the actuating mechanism 14 actuates the digital camera module 12 to rotate the lens device 121 to face the photographing opening 112, as shown in FIGS. 4 and 5, such that the user can take pictures.

In summary, the portable terminal apparatus of the invention has the lens device of the digital camera module facing the power key, and the power key is pervious to light. So, when the finger of the user presses the power key, the digital camera module can photograph the finger and store the fingerprint image into a memory of the portable terminal apparatus. When the digital camera module again obtains another fingerprint image, the portable terminal apparatus can perform a comparison such that the fingerprint recognition operation may be implemented. Compared with the prior art, the invention only utilizes the inherent devices, such as the digital camera module and the power key of the portable terminal apparatus to implement the fingerprint recognition function. So, the production time and cost can be reduced, and the efficiency of use, the reliability and the privacy of the product can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A portable terminal apparatus, comprising:
a main body;
a power key disposed on and exposed from the main body, wherein the power key is pervious to light; and
a digital camera module, which is disposed inside the main body and has a lens device facing the power key.

2. The portable terminal apparatus according to claim 1, further comprising:
a photographing opening disposed on and exposed from the main body; and
an actuating mechanism, which is disposed inside the main body and connected to the digital camera module, wherein the lens device faces the power key or the photographing opening in accord with a movement of the actuating mechanism.

3. The portable terminal apparatus according to claim 2, wherein the portable terminal apparatus has a fingerprint recognition mode in which the actuating mechanism actuates the lens device to face the power key, and a photographing mode in which the actuating mechanism actuates the lens device to face the photographing opening.

4. The portable terminal apparatus according to claim 2, wherein the power key and the photographing opening are respectively disposed on and exposed from two adjacent side surfaces of the main body.

5. The portable terminal apparatus according to claim 2, wherein the actuating mechanism has a rotatable arm and a hinge, the rotatable arm is connected to the digital camera module and the hinge, and the rotatable arm and the lens device are rotated about the hinge.

6. The portable terminal apparatus according to claim 1, wherein the power key has a convex lens disposed inside the power key.

7. The portable terminal apparatus according to claim 1, further comprising:
a starting module having at least one push-push type structure, which is disposed inside the main body and adjacent to the power key.

8. The portable terminal apparatus according to claim 7, wherein the push-push type structure has an elastic member and two contact points, and the push-push type structure has a pressed state, in which the elastic member is pressed and the contact points contact each other, and a recovered state, in which the elastic member is recovered and the contact points are separated from each other.

9. The portable terminal apparatus according to claim 8, wherein the starting module further has a starting circuit electrically connected to one of the contact points.

10. The portable terminal apparatus according to claim 1, further comprising a starting module and a power managing module, wherein when the power key is pressed, the starting module transmits a starting signal to the power managing module.

11. The portable terminal apparatus according to claim 10, further comprising a memory, wherein the digital camera module captures a fingerprint image of a finger through the power key and transmits the fingerprint image to the memory.

12. The portable terminal apparatus according to claim 11, further comprising a comparing module for comparing the fingerprint image with another fingerprint image.

13. The portable terminal apparatus according to claim 12, wherein the power managing module supplies a power to the digital camera module, the memory and the comparing module.

14. The portable terminal apparatus according to claim 12, further comprising a main processor, wherein the comparing module transmits a booting signal or a wake-up signal to the main processor.

15. The portable terminal apparatus according to claim 1, wherein the portable terminal apparatus is a personal digital assistant, a mobile communication apparatus or a notebook computer.
